(19) United States
(12) Patent Application Publication
(10) Pub. No.: US 2016/0284240 A1
(43) Pub. Date: Sep. 29, 2016

(54) ULTRASOUND TRAINING SYSTEM BASED ON CT IMAGE SIMULATION AND POSITIONING

(71) Applicants: THE GENERAL HOSPITAL OF PEOPLE'S LIBERATION ARMY, Beijing (CN); BEIJING INSTITUTE OF TECHNOLOGY, Beijing (CN)

(72) Inventor: Ping Liang, Beijing (CN)

(73) Assignees: The General Hospital of People's Liberation Army, Beijing (CN); BeijingInstitute of Technology, Beijing (CN)

(21) Appl. No.: 14/898,525

(22) PCT Filed: Jun. 18, 2014
(86) PCT No.: PCT/CN2014/000598

§ 371 Date: Apr. 20, 2016

(30) Foreign Application Priority Data
Jun. 19, 2013 (CN) 201310244882.1

(51) Int. Cl. G09B 23/28; G09B 23/30

(52) U.S. Cl. CPC G09B 23/286; G09B 23/30

(57) ABSTRACT

The invention relates to an ultrasound training system based on CT (computed tomography) image simulation and positioning, the real-time performance of which is improved through GPU (graphics processing unit) acceleration-based realization of ultrasound image simulation and CT volume data rendering. In the system, a curved surface matching module is used for performing surface matching between read human body CT volume data and physical model data with a physical model serving as the standard, and for realizing elastic transformation of a curved surface by means of an interpolation method based on a thin plate spline; an ultrasound simulation probe pose tracking module is used for computing the pose of an ultrasound simulation probe with respect to the physical model in real time by means of a mark point tracking method, and for acquiring CT image slices at any angle according to a pose matrix; an image enhancement and ultrasound image simulation generating module is used for improving the vessel contrast of a CT image by means of a multiscale enhancement method, and for simulating the ultrasound image based on the CT volume data; and a fusion display module is used for rendering and displaying the CT volume data based on the acceleration of CUDA (compute unified device architecture), and for fusing and displaying an ultrasound simulation image and a three-dimensional CT image according to the acquired pose matrix.

### REFERENCE TO RELATED APPLICATION

This US application claims the benefit of the filing date of China application serial No. 201310244882.1 filed on Jun. 19, 2013, and the benefit of filing date of PCT application No. PCT/CN2014/000598 filed on Jun. 18, 2014, both entitled “ULTRASOUND TRAINING SYSTEM BASED ON CT IMAGE SIMULATION AND POSITIONING”. The teachings of the entire referenced applications are incorporated herein by reference.

### TECHNICAL FIELD

The invention relates to an ultrasound training system based on CT image simulation and positioning, which is applicable to the field of medical ultrasound training.

### BACKGROUND ART

When ultrasound spreads in a human body, ultrasound will produce physical phenomena such as reflection, refraction, scattering and Doppler frequency shift at an interface between two different tissues due to differences among acoustic properties of various human tissues. An ultrasound diagnostic apparatus is used for receiving reflection and scattering signals, so that the morphologies of various tissues and pathological changes thereof can be displayed, and physicians can make an accurate diagnosis on the site, nature and dysfunction extent of the pathological changes in conjunction with pathology and clinical medicine.

In addition, ultrasound can be widely applied to the guiding process of minimally invasive surgeries in clinical practice due to no radiation and high imaging speed of ultrasound. However, as the physiological structures of human bodies, which are displayed by ultrasound images, are not intuitive due to the problems of complexity of ultrasound imaging principles and noise interference, only doctors with rich experience and knowledge can make an accurate judgment on focus. The traditional ultrasound training of medical staff is completed under the direction of experienced ultrasound physicians through real surgeries, and the training method is high in cost and can cause pains or complications for patients due to improper operation of trainees. Thus, the ultrasound simulation training system serving as an economic and effective training manner develops rapidly.

At present, there are two broad categories of ultrasound simulation training systems which are a simulation system based on ultrasonic three-dimensional volume data and an ultrasound simulation system based on CT volume data, wherein the simulation system based on ultrasonic three-dimensional volume data can obtain an accurate simulation effect only when an ultrasound probe detects data in the range of acquired ultrasound three-dimensional volume data, and once the probe is not in the range, the distortion factor of the simulation image is high; and the ultrasound simulation system based on CT volume data superposes random noise images, spread images, absorption images and reflection images constructed based on the CT volume data so as to obtain the ultrasound simulation images and has the advantages that CT images are easier to obtain, and the information of stimulation images and source images may be fused so as provide more comprehensive pathologic conditions of patients for physicians. This type of ultrasound stimulation system is a hot research area at home and abroad, and certain results have been obtained, for example, UltraSim system developed by University of Oslo, Norway, SONOSim3D system developed by Stralsund University of Science and Technology, Germany and the like. However, several aspects of limitations still exist:

1. An ultrasound image simulation method based on CT volume data is high in computation complexity and difficult to meet the requirements of medical ultrasound training on timeliness;

2. As accuracy displayed by three-dimensional volume data rendering and image fusion is in direct proportion to algorithm complexity, and when timeliness is met, the information of the three-dimensional structure of the image is incomplete, and the display result is blurred;

3. As the Doppler effect does not occur in blood during CT imaging, the distortion factor of vessels in ultrasound stimulation images based on CT images is high, and yet the vessels (especially the liver, kidneys and the like) are an important basis for judging focuses of organs;

4. Shapes and positions of organs and tissues in abdominal cavities of human bodies vary from person to person, and the elastic matching between simulated three-dimensional volume data and a real object needs to be completed when the same physical model is used for simulating the abdominal cavities of different human bodies.

Thus, a real-time ultrasound image simulation system needs to meet the following conditions: (1) the ultrasound simulation of the human body at any angle can be realized, so that the comprehensive diagnosis on patients can be realized; (2) the simulation images have higher authenticity; (3) the computation speed is high; and (4) the ultrasound simulation image and three-dimensional volume data need to be fused in real time so as to further improve the status of the ultrasound simulation system in surgical navigation, virtual surgeries and other clinical medicine fields.

### SUMMARY OF THE INVENTION

The invention provides an ultrasound training system based on CT (computed tomography) image simulation and positioning in order to overcome deficiencies of the ultrasound simulation training system in prior art. The real-time performance of the ultrasound training system based on CT image simulation and positioning is improved through GPU (graphics processing unit) acceleration-based realization of ultrasound image simulation and CT volume data rendering. A convenient tool is provided for ultrasound training.

The ultrasound training system based on CT image simulation and positioning comprises a curved surface matching module, an ultrasound simulation probe pose tracking module, an image enhancement and ultrasound image simulation generating module and a fusion display module;

the curved surface matching module is used for performing surface matching between read human body CT volume data and physical model data with a physical model serving as the standard, and for realizing the elastic transformation of the curved surface by means of an interpolation method based on a thin plate spline;

the ultrasound simulation probe pose tracking module is used for computing the pose of the ultrasound simulation probe with respect to the physical model in real time by means of a mark point tracking method, and for acquiring CT image slices at any angle according to a pose matrix;

the image enhancement and ultrasound image simulation generating module is used for improving vessel contrast of a CT image by a multiscale enhancement method, and for simulating the ultrasound image based on the CT volume data;

the fusion display module is used for rendering and displaying the CT volume data based on the acceleration of CUDA, and for fusing and displaying an ultrasound simulation image and a three-dimensional CT image according to an obtained pose matrix.

The curved surface matching module performs surface matching by an octree-based curved surface matching method, and specifically comprises the following steps:

(1) Selecting mark points in images to be registered, namely on surfaces of human body abdominal cavity model data;

(2) Establishing a corresponding relationship between the mark points of the two images;

(3) Loading the mark points of the two images into a GPU in a form of texture, and in the GPU, solving registration transformation between the images by an octree-based matching algorithm;

(4) Allowing the obtained transformation to act on the images to be registered to achieve the elastic matching of the images, and realizing the elastic transformation of the curved surface by means of the interpolation method based on the thin plate spline.

Compared with existing ultrasound simulation training systems, the system provided by the invention has the following advantages:

1. The pose of an ultrasound simulation probe is computed in real time by the mark point tracking method; the computation complexity is low; the pose matrix is accurate; and CT slice images at any angel can be obtained in real-time, thus facilitating ultrasound simulation;

2. On the basis of determining the corresponding relationship between the mark points, the surface matching between the CT volume data and the physical model data is completed by means of the octree-based matching algorithm to improve applicability and practicality of the system;

3. With respect to the CT volume data surface and the physical model surface data, the elastic deformation of the curved surface is realized by means of the interpolation method based on the thin plate spline;

4. CT data is pretreated by a multiscale vessel enhancement algorithm so as to increase vessel contrast and improve the authenticity of vessel simulation in CT data-based ultrasound simulation images;

5. CT volume data noise is used for simulating ultrasound image noise so as to reduce complexity of the ultrasound simulation algorithm;

6. The CT volume data and the ultrasound simulation images are fused and displayed so as to provide more comprehensive pathological information of patients for physicians;

7. The ultrasound simulation and volume data three-dimensional visualization are completed based on the parallel computation of the GPU so as to improve the operating efficiency of the system.

### BRIEF DESCRIPTION OF THE DRAWINGS

FIG. 1 is a work flow diagram set forth in the invention;

FIG. 2 is a frame diagram of the ultrasound simulation system set forth in the invention;

FIG. 3 is processing modules of CPU and GPU of the ultrasound simulation system set forth in the invention;

FIG. 4 is a flow chart of ultrasound image simulation based on GPU acceleration set forth in the invention;

FIG. 5 is a user operational flow chart set forth in the invention.

### DETAILED DESCRIPTION OF THE INVENTION

The invention is described in details below with the reference to specific embodiments and the drawings, and yet the invention is not limited to the above.

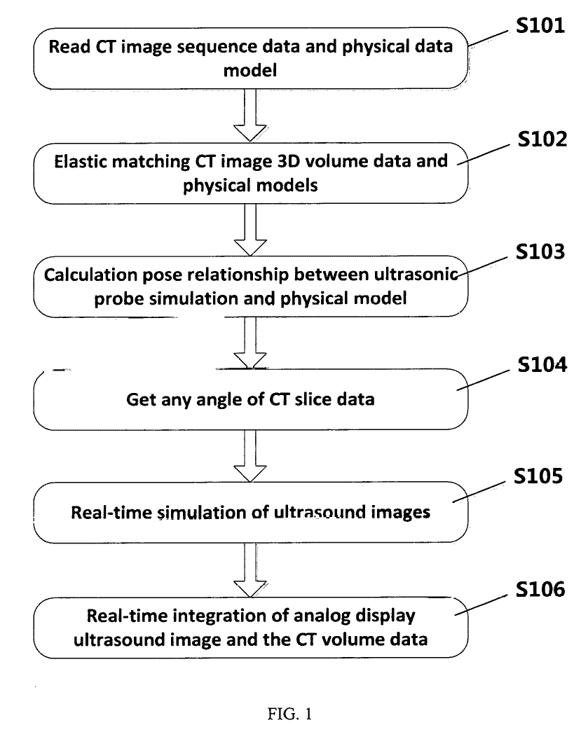

FIG. 1 is a flow chart of reconstruction, and the ultrasound simulation training system comprises the following steps:

In the step S101, CT sequence image data is read so as to serve as source images for ultrasound simulation, and human body abdominal cavity physical model data is read.

In the step S102, The surface matching between the CT volume data and the human body abdominal cavity model data is completed by means of the octree-based matching algorithm with the read human body abdominal cavity physical model data serving as the standard and the read CT sequence image data serving as the images to be registered. The procedures of elastic registration based on the octree-based algorithm are as follows:

(1) selecting a certain number of mark points in the image to be registered, namely on surfaces of human body abdominal cavity model data;

(2) establishing a corresponding relationship between the mark points of the two images;

(3) loading the mark points of the two images into the GPU in a form of texture, and in the GPU, solving registration transformation between the images by the octree-based matching algorithm;

(4) allowing the obtained transformation to act on the image to be registered to achieve the elastic matching of the images, and realizing the elastic transformation of the curved surface by means of the interpolation method based on the thin plate spline.

The octree-based curved matching disintegrates the three-dimensional model from the whole to parts. Root nodes form the first level of the octree and are used for comparison of overall similarity of the three-dimensional model, the comparison of nodes at a higher level indicates the comparison of partial details, and therefore, the three-dimensional model can be matched from the whole to parts through the octree. In addition, the ultimate matching result of the octree is independent of the coordinate system.

In the process of thin plate spline interpolation, the distortion of the curved face of a thin plate under the constraint of several points can be described in a graphic manner, thus ensuring the distortion factor of the thin plate on a point (xᵢ, yᵢ) to be qᵢ and causing the thin plate to have the minimum curved energy E_{TPS}(f) distortion. Specifically, when the conditions of constraining f(xᵢ, yᵢ)=qᵢ(i=1, 2, . . . , n) are met, the minimized distorted energy E_{TPS}(f) of the interpolation function f(x, y) is sought:

$${E}_{TPS} ( f ) = \int \int \vert \vert \frac{{\partial }^{2} f}{\partial {x}^{2}} \vert + \vert \frac{{\partial }^{2} f}{\partial x \partial y} \vert + \vert \frac{{\partial }^{2} f}{\partial {y}^{2}} \vert \vert d x d y \qquad ( 1 )$$

The thin plate spline model provides the interpolation function f(x, y) that can minimize distorted enemy E_{TPS}(f):

$$f ( x , y ) = {Φ}_{s} ( x , y ) + {R}_{s} ( x , y ) = {a}_{1} + {a}_{x} x + {a}_{y} y + {\sum }_{i = 1}^{n} {w}_{i} U ( \vert {p}_{i} - ( x , y ) \vert ) \qquad ( 2 )$$

Wherein the basis function U(rᵢ)=rᵢ² log rᵢ² of the thin plate spline is the basic solution of the biharmonic function (Δ²U=δ(0, 0); r₉ is the distance from the point p(x, y) to a mark point pᵢ, and rᵢ=|pᵢ−(x, y)|.

The step realizes the elastic matching between the human body abdominal cavity model data and the CT sequence image surface, thus ensuring the applicability and practicability of the system.

In the step S103, when the probe moves on the human body abdominal cavity physical model, the position and pose of the ultrasound probe labeled with the mark point relative to the human body abdominal cavity physical model are computed in real time by means of the mark point tracking method, and human body data slices are intercepted according to the information of the position and pose of the ultrasound probe.

In the step S104, re-slices of any parts of a human body can be obtained by means of the CT image sequence. Firstly, the CT image sequence obtained after curved surface matching is transformed into 3D volume data through spatial sampling; then, the voxel resolution ratios of three directions are transformed into isotropy by means of a tri-linear interpolation algorithm; after that, the position of the ultrasound simulation probe relative to the CT abdominal cavity volume data is determined and the slice direction is obtained (depending mainly on a normal vector and points on a plane) through the obtained information of position and pose relationship of the physical ultrasound probe; and finally, the slice is intercepted from the volume data.

In the step S105, the CT volume data is pretreated so as to improve the vessel contrast of the CT image, the enhanced data is input into a GPU (Graphics Processing Unit) terminal where the parallel ultrasound simulation computation is carried out, and after that, the ultrasound simulation image can be obtained in real time.

The vessel enhancement treatment is carried out on the CT volume data which is read in by means of the multiscale vessel enhancement algorithm, and the enhanced image and the source image are superposed by weight. The superposition formula is shown below:

$$U = \{ \begin{matrix}{U}_{source} ( {x}_{0} ) , & I ( {x}_{0} ) = 0 \\ ( 1 - w ) {U}_{source} ( {x}_{0} ) + w {U}_{enhance} ( {x}_{0} ) C , & I ( {x}_{0} ) > 0\end{matrix} \qquad ( 3 )$$

wherein U indicates an image obtained after the processing image and the source image are superposed, U_{source} indicates the source image, U_{enhance} indicates the image which is subjected to multiscale vessel enhancement, and w indicates weight C is a constant and aims at linearly stretching the treated vessel enhanced image. Since the value range of the pixel value of the image treated by means of the multiscale vessel enhancement algorithm is [0, 1], the pixel is of a non-tubular structure when the pixel value is 0, the pixel is of a tubular structure when the pixel value is not 0, and the greater the pixel value is, the closer the pixel is to the center line of the tubular structure.

In the step S106, the CT volume data and the ultrasound simulation image are fused and displayed in the GPU; the fusion and display step is realized by means of double threads, the first thread is used for realizing tracking of the ultrasound probe and acquiring a translation matrix and a rotation matrix of the probe, and the second thread is used for reading the CT volume data so as to complete real-time three-dimensional visualization of the human body data, meanwhile the re-slices are obtained from the human body data according to the position and pose information of the probe output by the first thread, the ultrasound real-time simulation is carried out, and finally the visualization and the fusion display of the ultrasound simulation image are carried out.

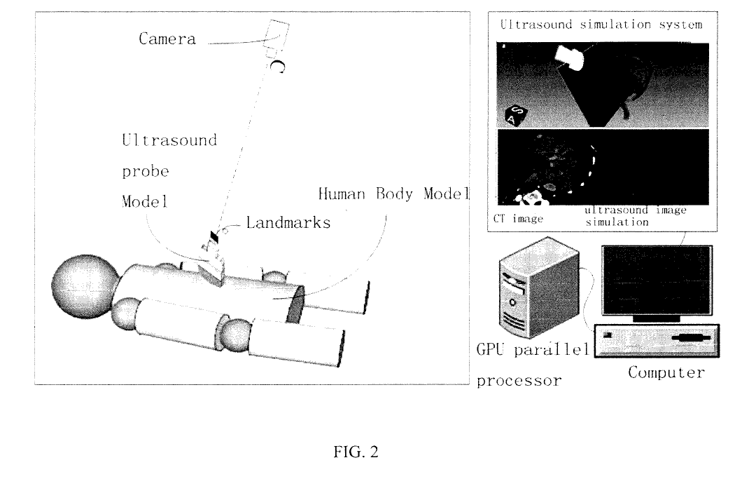

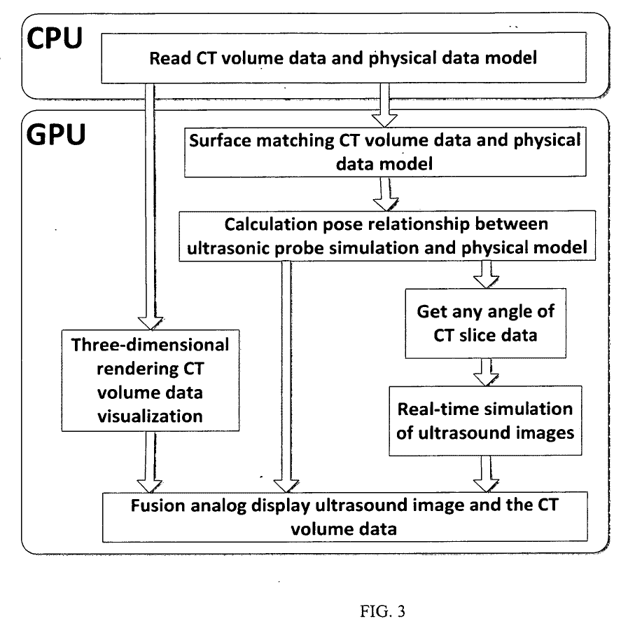

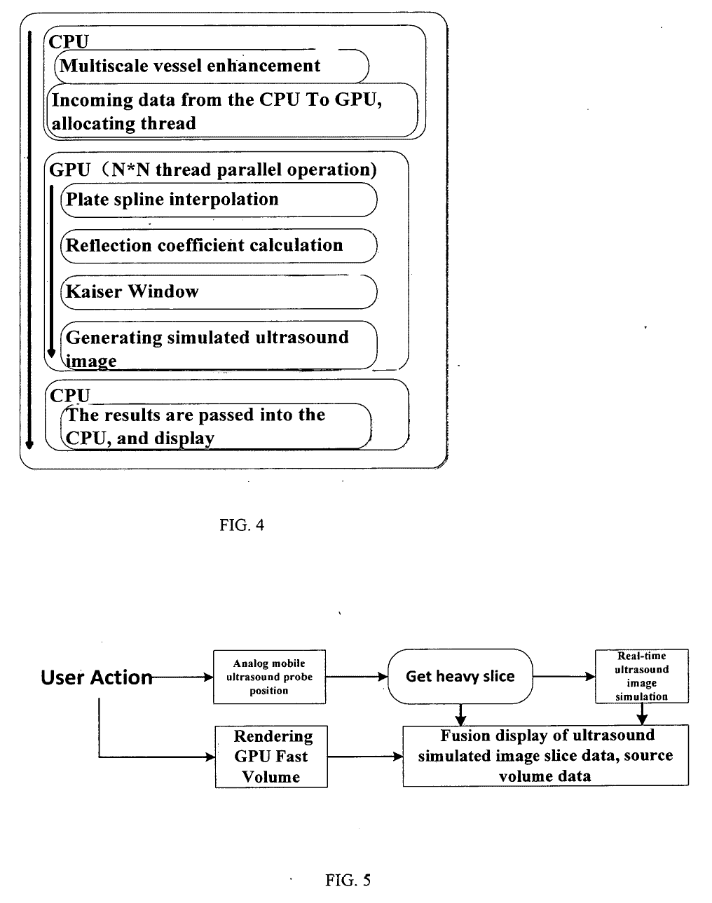

FIG. 2 is a schematic diagram of system construction, and the ultrasound simulation training system comprises the following several modules:

a camera which is used for acquiring information of the mark point at the terminal of an ultrasound probe model;

the ultrasound probe model, the terminal of which is labeled with the mark point used for tracking and computation of the position and pose of the probe, wherein the ultrasound probe can be put at any position of a human body model;

the human body model, surface point cloud data of which needs to be collected and which is used for surface matching with the CT volume data surface which is read in;

a computer which is used for computation of position and pose of the ultrasound probe, matching of CT volume data and the human body model, real-time simulation of the ultrasound image and GPU acceleration.

While the invention is described with the reference to the preferred embodiments, the embodiments mentioned above should not be constructed as limitations on the protection scope of the invention, and all modifications, equivalent substitutions, improvements and the like made within the spirit and principles of the invention should be fallen within the claimed protection scope of the invention.

1. An ultrasound training system based on CT image simulation and positioning, characterized by comprising a curved surface matching module, an ultrasound simulation probe pose tracking module, an image enhancement and ultrasound image simulation generating module and a fusion display module;
wherein the curved surface matching module is used for performing surface matching between read human body CT volume data and physical model data with a physical model serving as the standard, and for realizing elastic transformation of a curved surface by means of an interpolation method based on a thin plate spline;
the ultrasound simulation probe pose tracking module is used for computing the pose of an ultrasound simulation probe with respect to the physical model in real time by means of a mark point tracking method, and for acquiring CT image slices at any angle according to a pose matrix;
the image enhancement and ultrasound image simulation generating module is used for improving vessel contrast of a CT image by a multiscale enhancement method, and for simulating the ultrasound image based on the CT volume data; and the fusion display module is used for rendering and displaying the CT volume data based on the acceleration of CUDA, and for fusing and displaying an ultrasound simulation image and a three-dimensional CT image according to the acquired pose matrix.

2. The ultrasound training system based on CT image simulation and positioning of claim 1, characterized in that the curved surface matching module performs the surface matching by an octree-based curved surface matching method, and specifically comprises the following steps:
(1) selecting mark points in images to be registered, namely on surfaces of human body abdominal cavity model data;
(2) establishing a corresponding relationship between the mark points of the two images;
(3) loading the mark points of the two images into a GPU in a form of texture, and in the GPU, solving registration transformation between the images by an octree-based matching algorithm;
(4) allowing the obtained transformation to act on the images to be registered to achieve the elastic matching of the images, and realizing the elastic transformation of the curved surface by means of the interpolation method based on the thin plate spline.

3. The ultrasound training system based on CT image simulation and positioning of claim 1 or 2, characterized in that during computing the pose of the ultrasound physical probe with respect to an abdominal cavity physical model in real time by means of a mark point tracking method, after rotation and translation matrices are acquired, a pose relationship between the ultrasound simulation probe and the CT volume data is acquired according to the pose information so as to acquire a human body data slice image.

4. The ultrasound training system based on CT image simulation and positioning of claim 1 or 2, characterized in that the simulation of the ultrasound image is realized based on the CT volume data by the steps of: firstly improving the vessel contrast of the CT image by a multiscale vessel enhancement algorithm, then computing a reflection coefficient of a tissue interface according to the principle of ultrasound propagation, and computing through GPU accelerated ultrasound reflection and scattering phenomena and through a window function.

5. The ultrasound training system based on CT image simulation and positioning of claim 1 or 2, characterized in that at the end of rendering and displaying of the CT volume data, a global illumination model is used for increasing the authenticity of the images.
